(19) United States
(12) Patent Application Publication
(10) Pub. No.: US 2005/0168325 A1
(43) Pub. Date: Aug. 4, 2005

(54) Device for reading/interrogating for information about the state of preservation of a substance

(76) Inventors: Jerome Lievre, Villennes Sur Seine (FR); Fidel Peralle, Viroflay (FR); Axel Glaeser, Tauffelen (CH)

Correspondence Address: PERMAN & GREEN, 425 POST ROAD, FAIRFIELD, CT, 06824, US

(21) Appl. No.: 11/039,345

(22) Filed: Jan. 20, 2005

(30) Foreign Application Priority Data
Jan. 23, 2004 (FR) FR 04 00642

(51) Int. Cl. G08B 1/08

(52) U.S. Cl. 340/10.6; 340/539.26; 340/10.41

(57) ABSTRACT

An RFID read/interrogate device including: memory means for storing data about the state of preservation of a substance; transmit/receive means connected to the memory means via processor means for reading the data from an RFID tag delivering the data about the state of preservation of a substance, including at least temperature data; power supply means; clock means for periodically delivering a clock signal to the processor means, the processor means periodically interrogating the RFID tag and storing the state data in the memory means at the rate of the clock signal delivered by the clock means so as to enable the state of preservation of a substance equipped with the RFID tag to be determined in real time; and display means for viewing information about the substance and the state of preservation of the substance. A container provided with such a device.

### TECHNICAL FIELD

The present invention relates to the field of the food, chemicals, or pharmaceuticals industries, and it relates more particularly to a radio-frequency identification (RFID) read/interrogate device and to a container associated with said device, the device and the container making it possible continuously to detect and to give information about the state of freshness and of preservation of a perishable foodstuff, a medicinal drug, or else a chemical substance liable to become contaminated that is placed inside said container.

### PRIOR ART

Today, foodstuffs are subjected to quality control that is increasingly strict while they are being prepared and while they are being transported and stored. That is why chemical indicators or tags such as “freshness” patches are encountered on a large number of perishable foodstuffs, making it simple for them to be inspected visually for unacceptable nutritional quality or for expired shelf lives. U.S. Pat. No. 5,317,987 is a good example of such an indicator. Unfortunately, such visual indicators give information only about a determined state of the substance, and not about a change in said state over time.

Since Svante August Arrhenius's work in 1889, it has been known that temperature plays a major part in how the quality of foodstuffs deteriorates and, more particularly, that the variation in temperature over the life of the substance is essential for determining the state of preservation of said substance. This observation underlies research and development for electrochemical tags such as those described in U.S. Pat. No. 6,294,997 which use radio-frequency identification (RFID) technology improved by adding a timing module. With such an RFID tag, it becomes possible to obtain more accurate information about changes in temperature over a period of time defined by the timing module.

However that determined period of time is limited as a function of pre-established conditions for triggering or stopping the timing module and it is not therefore sufficient for obtaining a full assessment of the states of the substance throughout its life. Therefore, there still exists a need for a device capable of continuously detecting and giving information about the state of freshness and of preservation of a perishable foodstuff, of a medicinal drug, or of any other chemical substance that is liable to become contaminated.

### OBJECT AND DEFINITION OF THE INVENTION

An object of the present invention is thus to satisfy the above-mentioned need by proposing a device that is based on RFID technology and that guarantees the nutritional quality of the substance with greater certitude. Another object of the invention is to guarantee that the substance can be tracked and checked at any time between being manufactured and being sold.

These objects are achieved by an RFID read/interrogate device comprising: memory means for storing data about the state of preservation of a substance; transmit/receive means connected to the memory means via processor means for reading said data from an RFID tag delivering said data about the state of preservation of a substance, including at least temperature data; power supply means; clock means for periodically delivering a clock signal to the processor means, said processor means periodically interrogating said RFID tag and storing said state data in said memory means at the rate of the clock signal delivered by said clock means so as to enable the state of preservation of a substance equipped with said RFID tag to be determined in real time; and display means for viewing information about said substance and said state of preservation of said substance.

Thus, by means of this periodic and real-time interrogation of data relating to the state of preservation of the substances, it is possible to be certain of acquiring a substance whose freshness quality is guaranteed and can be checked by direct display.

Preferably, the RFID read/interrogate device further includes a communications interface for transferring the data coming from various RFID tags to a common administration member via a communications network.

Advantageously, said state data further includes one or more of the following types of data: humidity data, acidity data, pressure data, and biological data.

The memory means may further contain data taken from at least: a reference for the substance, a price therefor, a date of manufacture thereof, and a “sell-by” date beyond which the substance may no longer be sold.

Depending on the desired use, the substance is constituted by a perishable foodstuff, by a medicinal drug, or by a chemical substance that is liable to become contaminated.

The present invention also provides a container provided with the above-mentioned RFID read/interrogate device.

### BRIEF DESCRIPTION OF THE DRAWINGS

The invention will be better understood on reading the following detailed description accompanied by illustrative and non-limiting examples with reference to the following figures, in which:

FIG. 1 shows the internal structure of an RFID tag implemented in the invention;

FIG. 2 shows an example of a read/interrogate device of the invention adapted to read and interrogate RFID tags of the type shown in FIG. 1; and

FIG. 3 shows an example of use of the device of FIG. 2 in a food store.

### DETAILED DESCRIPTION OF EMBODIMENTS

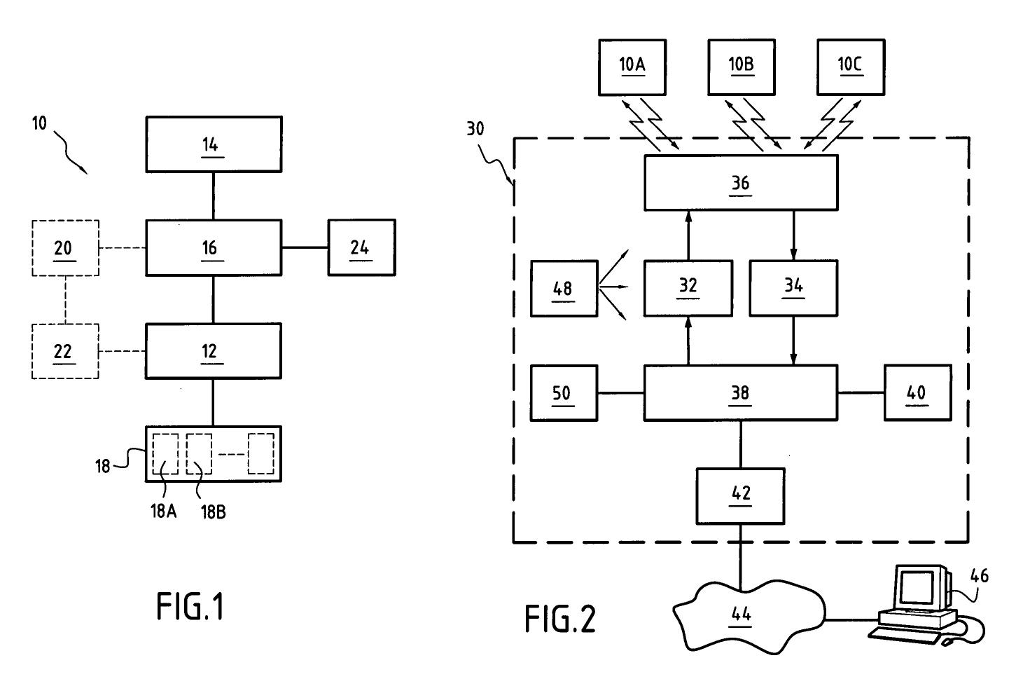

An RFID tag 10 for determining the state of preservation of a substance and serving to co-operate with a read/interrogate device of the present invention is shown in FIG. 1. Conventionally, and like any RFID tag, it includes: memory means 12 for storing data, and transmit/receive means 14 connected to the memory means via processor means 16 for transmitting said data to an external reader/interrogator 30 (see FIG. 2). Said memory means are of the following types: random access memory (RAM), read-only memory (ROM), Flash memory or some similar type, and said memory means make it possible to store both data and also elements of program making it possible for the processor means to operate properly. Said processor means are advantageously of the microprocessor, programmable logic, or microcontroller type. In known manner, the transmit/receive means include an antenna and modulate/demodulate means for transforming the signals received by the antenna into data usable by the processor means and vice versa.

In order to enable the RFID tag to be used for determining the state of preservation of a substance such as a foodstuff, a medicinal drug, or a chemical substance that is liable to become contaminated, provision is made for said RFID tag to incorporate detector means 18 for taking readings of data about the state of preservation of the substance. Said data consists at least of temperature data (according to Arrhenius, temperature is an essential parameter in determining the state of preservation of substances), and it can advantageously also incorporate data relating to the humidity of the substance, to the acidity, and to the pressure thereof, or indeed, without being limiting, to the biological type and composition of said substance. Conventional sensors (a temperature sensor 18A, a humidity sensor 18B, etc.) connected to the processor means make it simple to take readings of said data with a predetermined periodicity as a function of a clock signal. Depending on whether the RFID tag is of the semi-passive type or of the passive type, it can (if it is a semi-passive tag) include power supply means 22 for powering the processor means and for enabling the data stored in the memory means to be backed up.

When the RFID tag is of the semi-passive type, it can also include clock means 20 for delivering a clock signal periodically to the processor means, the periodicity of the data readings then being based on said clock signal. Thus, at the rate of the clock signal, the processor means can, periodically and in real time, store data relating to the state of preservation of the substances. On the basis of such data, and as a function of the elements of program to which they have access, said processor means can also actuate a visual alarm (e.g. on a liquid crystal display (LCD) screen) or a sound alarm (e.g. a buzzer) indicating unacceptable nutritional quality (e.g. that the substance is unfit for consumption). The term “unacceptable nutritional quality” should be understood as indicating, for example, that a temperature threshold has been crossed for a time longer than a predefined lapse of time, or else humidity that is higher than a predetermined value (such threshold values naturally being pre-stored in the memory means).

Conversely, when the RFID tag is of the passive type, the clock signal on the basis of which the periodicity of the data readings is determined is generated in the read/interrogate device co-operating with said tag.

FIG. 2 is a block diagram showing such a reader/interrogator of the invention that is designed to co-operate with one RFID tag or more generally with a plurality of RFID tags 10A, 10B, 10C that are advantageously of the passive type, and that are as described above. These elements communicate by inductive coupling as is well known. The reader/interrogator includes a transmitter 32, a receiver 34 both of which are connected to an antenna 36, a data-processing and control circuit 38 incorporating memory means, and a display 40. The transmitter 32 generates a power signal and an interrogate signal for the antenna which transmits an electromagnetic field towards the various RFID tags that come into its zone of coverage. An anti-collision protocol of known type is naturally necessary in order to avoid simultaneous interrogations and responses. The receiver 34 then detects a change in the electromagnetic field due to data being transmitted from an RFID tag powered via the power signal, and transmits the collected data to the processor means 38 which, on request, display said data about the display means 40. Said data is constituted by the above-mentioned variable state data from the detector means, and also by data that is pre-recorded during packaging of the substance, e.g.: a reference, a price, a date of manufacture, a “sell-by” date, etc.

When the RFID tag is of the passive type, it is the read/interrogate device that includes the clock means (referenced 50). It is then possible to interrogate the RFID tags with a short periodicity (e.g. every minute from 0 hours to 24 hours) in uninterrupted manner. In this configuration, it is no longer necessary to store the data from the detector means between interrogations, and thus to manage the history of the data at the RFID tag. Each interrogation by the reader/interrogator, corresponds to immediate reading of the detector means and to simultaneous sending of the collected data to the interrogator. In addition, the interrogation is preceded by delivering power that is sufficient to perform the reading. Between occasions on which detection takes place, a passive RFID tag cannot perform any reading of its detector means.

The reader/interrogator is advantageously provided with a communications interface 42 in order to transfer the read data via a communications network 44 to a remote administration member 46, e.g. a management computer. When the reader/interrogator is portable, the communications interface is preferably of the wireless type, namely of the infrared or short-range radio types (Bluetooth or Wi-Fi). It can be wired when the interrogator device is a fixed device. Naturally, power supply means 48 are also provided in order to make the electromagnetic transmission possible and in order to power the processor means in particular. They are advantageously of the optionally rechargeable battery type when the device is portable, and of the AC-to-DC converter type when the device is a fixed device.

Using the tag-interrogator set of the invention is thus very simple. It is necessarily merely to affix an RFID tag to the substance to be monitored, which tag delivers data about the state of preservation of the substance, which data includes at least temperature data, and then to use a reader/interrogator to interrogate said RFID tag with a periodicity predetermined as a function of a clock signal in order to retrieve said state data, and then to determine the state of preservation of the substance as a function of the state data retrieved. The clock signal can be delivered by the RFID tag (when it is a semi-passive tag) but it is preferably delivered by the reader/interrogator (when the tag is a passive tag). The periodicity with which the RFID tag is interrogated can optionally be a single predetermined fixed periodicity. The data concerning the state of preservation of the substance, as well as other data relating to the substance itself can also be displayed on the display means 40, and can thus be accessible directly at the read/interrogate device which can, for example, display a value indicating an unacceptable nutritional quality. Advantageously, said data is forwarded via a communications network to a common administration member that can centralize the data coming from various tags for management purposes.

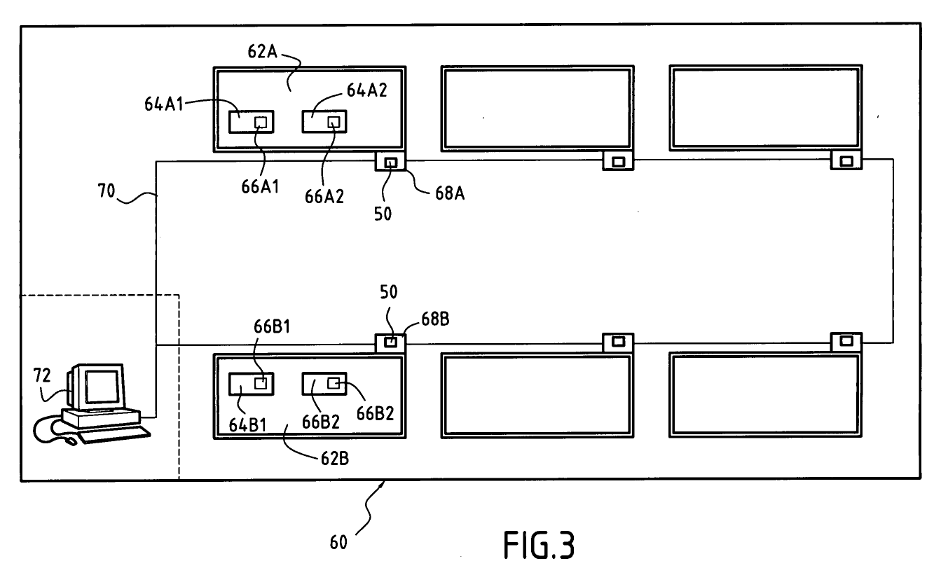

A preferable example of use of this simplified configuration is shown in FIG. 3 which shows a hall or a store 60 containing a plurality of deep freezers (typically several tens of deep freezers 62A, 62B, etc.), each of which contains a plurality of items of frozen food (typically several tens of items of frozen food 64A1, 64A2, 64B1, 64B2, etc.). Each of the items of food is provided with a passive RFID tag 66A1, 6A2, 66B1, 66B2, etc., i.e. an RFID tag without any power supply means or clock means. Each deep freezer is provided with a reader/interrogator 68A, 68B incorporating a display 40 and clock means 48 for periodically and automatically interrogating the RFID tags on the items of food it contains. Each reader is also connected via a communications network 70 for the store to a management computer 72 disposed in a room in which the manager of the store can thus monitor the state of preservation of all of the items of food in the store in real time (with the periodicity that the manager has set). This monitoring takes place on the manager's management computer without it being necessary for the manager to visit a deep freezer directly. Such a visit is only necessary when the manager is informed of an item of food that is unfit for consumption, i.e. informed of the result of an interrogation of the item of food that has shown it to have gone past its “sell-by” date, or to have gone beyond certain predetermined thresholds.

With this type of management, customers of the store are sure that they are purchasing an item of frozen food whose nutritional quality (freshness) is guaranteed, the reader/recorder of the deep freezer, with its display screen, enabling customers personally to check clearly and precisely all of the information concerning the item of food that they select and the state of preservation (quality) thereof: type and composition, dates of manufacture and of storage, temperature history, biological quality, “sell-by” date, etc.

It should be noted that this configuration can be extended, under certain conditions, to the entire cold chain from manufacturing to sale of the food. For this purpose, it is necessary merely for the items of frozen food to be monitored continuously while they are being stored or transported. For example, it can be imagined that such items of food, each of which is equipped with a passive RFID tag, from manufacture to sale, are always transported or stored in refrigerated containers, each of which is provided with a reader/interrogator of the invention. U.S. Pat. No. 4,831,837 describes a transport system making such refrigerated storage possible all the way along the cold chain, and the invention is quite suitable for being applied to such a system.

It should also be noted that such a storage configuration can concern substances other than perishable foodstuffs, and it is quite possible to imagine optionally refrigerated containers filled with medicinal drugs or containers in which substances are disposed and in which it is necessary to be informed in real time of the state of preservation of said substances, e.g. chemical substances that are liable to become contaminated.

1. An RFID read/interrogate device comprising: memory means for storing data about the state of preservation of a substance; transmit/receive means connected to the memory means via processor means for reading said data from an RFID tag delivering said data about the state of preservation of a substance, including at least temperature data; power supply means; clock means for periodically delivering a clock signal to the processor means, said processor means periodically interrogating said RFID tag and storing said state data in said memory means at the rate of the clock signal delivered by said clock means so as to enable the state of preservation of a substance equipped with said RFID tag to be determined in real time; and display means for viewing information about said substance and said state of preservation of said substance.

2. An RFID read/interrogate device according to claim 1, wherein said state data further includes one or more of the following types of data: humidity data, acidity data, pressure data, and biological data.

3. An RFID read/interrogate device according to claim 1, wherein said memory means further contain data taken from at least: a reference for the substance, a price therefor, a date of manufacture thereof, and a “sell-by” date beyond which the substance may no longer be sold.

4. An RFID read/interrogate device according to claim 1, further including a communications interface for transferring the data coming from various RFID tags to a common administration member via a communications network.

5. A container including a plurality of substances, each of which is provided with an RFID tag, the container being provided with an RFID read/interrogate device according to claim 1.

6. A container according to claim 4, wherein said substance is constituted by a perishable foodstuff.

7. A container according to claim 4, wherein said substance is constituted by a medicinal drug.

8. A container according to claim 4, wherein said substance is constituted by a chemical substance that is liable to become contaminated.
